(19) United States
(12) Patent Application Publication
(10) Pub. No.: US 2025/0244548 A1
(43) Pub. Date: Jul. 31, 2025

(54) SEMI-SINTERED THERMOMECHANICAL JOINTS IN AN OPTICAL TRANSCEIVER SUB-ASSEMBLY

(71) Applicant: Infinera Corp., Annapolis Junction, MD (US)

(72) Inventor: John W. Osenbach, Kutztown, PA (US)

(21) Appl. No.: 19/041,525

(22) Filed: Jan. 30, 2025

Related U.S. Application Data
(60) Provisional application No. 63/627,042, filed on Jan. 30, 2024.

(51) Int. Cl. G02B 6/42

(52) U.S. Cl. CPC G02B 6/4271; G02B 6/4269

(57) ABSTRACT

Consistent with the present disclosure, a photonic package assembly is described comprising at least one semi-sintered thermomechanical joint. The semi-sintered thermomechanical joint may be a TEC-to-heat sink mounting surface joint or PIC-to-TEC joint. The semi-sintered thermomechanical joint may have sufficiently high thermal conductivity to provide for effective TEC-to-heat sink mounting surface and PIC-to-TEC heat transfer, as well as sufficient ductility to maintain mechanical integrity in response to thermomechanical stresses such as TEC deformations. The semi-sintered thermomechanical joint may comprise a conductive material such as metal particles or powder dispersed in a persistent organic matrix material such as an epoxy.

### CROSS-REFERENCE/INCORPORATION BY REFERENCE

The present patent application claims priority to the United States provisional patent application identified by U.S. Ser. No. 63/627,042 filed on Jan. 30, 2024, the entire content of which is hereby incorporated herein by reference.

### BACKGROUND

Optical transmitter-receiver assemblies, also known as “transceivers”, are used in transport networks to transmit and receive data in the form of light. Optical transceivers comprise sub-assemblies known as “photonic packages” or “photonic package assemblies”. Photonic package assemblies used in optical transceivers comprise all necessary components for both converting a received light signal from a fiber optic cable to an electrical signal, and converting a received electrical signal to a light signal for transmission through a fiber optic cable. These components may include lasers, photodiodes, and modulators, integrated circuits implementing an optical driver(s) and amplifiers, and heat transfer devices such as a thermoelectric cooler, all within a hermetically sealed container configured as a heat sink.

The output power, wavelength, reliability, and general function of optical components is highly affected by their operating temperature. The temperature of these optical components must be tightly controlled such that the optical components may be precisely tuned over the operating wavelengths, such as the C-band or L-band wavelengths. To avoid moisture induced degradation in performance or reliability, such devices are typically housed within a hermetically sealed container. Precise temperature control is often provided within the hermetically sealed container which is typically at least one heat sink and the thermoelectric cooler mentioned above. The thermoelectric cooler is typically mounted to the hermetically sealed container configured as the heat sink, with a photonic device including a laser and a photodiode mounted onto the thermoelectric cooler. This allows the thermoelectric cooler to maintain temperature of the photonic device in the appropriate operating range typically by transferring heat from the photonic device to the hermetically sealed container.

Thermoelectric coolers operate according to the Peltier Effect, which permits the transfer of heat from one side of the thermoelectric cooler to the other side of the thermoelectric cooler based upon an application of electrical current to the thermoelectric cooler. However, as the temperature difference from the one side of the thermoelectric cooler to the other side, i.e., across the thermoelectric cooler, increases, efficiency of the thermoelectric cooler decreases and requires larger electrical currents. It therefore is imperative that, to maximize efficiency of the thermoelectric cooler, the photonic device is mounted to the thermoelectric cooler and the thermoelectric cooler is mounted to the hermetically sealed container, i.e., heat sink, by means of a high-thermal conductivity thermomechanical joint. These thermomechanical joints are ideally sufficiently thermally conductive such that heat is transferred effectively across the thermomechanical joint, minimizing the temperature drop across the thermomechanical joint. Further, these thermomechanical joints must be sufficiently robust to withstand a wide range of temperature excursions without loss of mechanical integrity. In addition to mechanical failure, any cracking or loss of mechanical integrity in a thermomechanical joint may cause air pockets which reduces thermal conductivity of the thermomechanical joint and decreases efficiency of the thermoelectric cooler.

Prior art solders are used to form these thermomechanical joints. There are various types of solder which have been used including relatively harder solders having higher reflow temperatures, and relatively softer solders having lower reflow temperatures. Because of the relatively large heat transfer area of thermoelectric coolers, which may be on the order of 100 mm² to 150 mm², the temperature gradient across the thermoelectric cooler causes a deformation or bowing effect. This deformation causes stresses which may break harder solders resulting in reduced thermal conductivity of the thermomechanical joint formed with the harder solders or loss of functionality of the thermoelectric cooler itself. Thus, hard solders have been typically reserved for smaller-sized thermoelectric coolers, such as those less than 50 mm².

To address the deformation of the thermoelectric cooler, particularly large thermoelectric coolers of greater than 50 mm², softer, more ductile solders such as Indium-Silver (InAg) have been used. Though InAg solder is more compliant with thermomechanical stresses, InAg solder has a relatively low melting point of 143° C. Thus, subsequent assembly handling and operational thermal excursions can cause the joint to reflow which may cause components to shift. Even slight shifts in components can cause issues in photonic packages leading to poor RF performance and optical alignment issues. Softer solders also permanently deform post-assembly under loads that might be imposed as a result of thermal stresses and strains. If permanent deformation occurs, permanent shift of components can occur leading to failure.

One method of avoiding reflow issues in other electronic circuitry is the use of sintered or semi-sintered joints. One such semi-sintered joint is LOCTITE® ABLESTIK ABP 8068TB, which is a semi-sintering paste comprised primarily of silver and to a lesser extent organic epoxy. However, this semi-sintering paste is only intended for small die applications up to 5 mm×5 mm where thermomechanical stresses are sufficiently low as to ensure joint stability.

Therefore, it is desirable to provide a photonic package assembly comprising a high thermal conductivity thermomechanical joint which remains intact over thermal conditions and thermal excursions experienced within the hermetically sealed container of an optical transceiver.

It is further desirable to provide a photonic package assembly comprising such a thermomechanical joint which may permit precise positioning of photonic components.

It is further desirable to provide a photonic package assembly comprising such a thermomechanical joint which may be applied to a thermoelectric cooler over an area ranging from 100 mm² to 150 mm².

It is to such desirable photonic package assemblies that the present disclosure is directed.

### SUMMARY

A photonic package assembly of an optical transceiver comprising at least one high-conductivity thermomechanical joint is disclosed. The prior art problem of hard solder joints fracturing under thermomechanical stresses imposed by the thermoelectric cooler, and soft solder joints causing movement of components during reflow, is addressed through at least one semi-sintered thermomechanical joint comprising conductive material dispersed in a persistent organic matrix material.

A thermoelectric cooler (“TEC”) of a photonic package assembly regulates the temperature of photonic devices such as lasers, which are highly-sensitive to temperature change. However, TECs are relatively large components in a photonic package assembly and can deform due to the temperature drop experienced from one side of the TEC. Thus, the joints which bind the TEC to the package heat sink, and the photonic device(s) to the TEC, must be sufficiently conductive to permit effective heat transfer while also being sufficiently robust to maintain integrity in response to thermomechanical stresses.

Thus, in an aspect of the present disclosure, the disclosure describes a photonic package assembly comprising a heat sink, a TEC having a first mounting surface and a second mounting surface, the first mounting surface mounted onto the heat sink mounting surface of the first heat sink with a first joint. The photonic package assembly may comprise a laser mounted to the TEC on the second mounting surface with a second joint, as well as an optical interconnect mounted onto either the second mounting surface or the heat sink mounting surface of the heat sink. The photonic package assembly may also comprise an electrical interconnect and an optical modulator receiving data signals from the electrical interconnect and operable to modulate data signals into light generated by the laser. The TEC may maintain the laser in a temperature range of 10° C. to 70° C.

The first joint may comprise a first persistent organic matrix material and a first conductive material dispersed within the first persistent organic matrix material, and the second joint may comprise a second persistent organic matrix material and a second conductive material dispersed within the second persistent organic matrix material. The first joint may have a first volume wherein the first persistent organic matrix material is in a range of 3-5% of the first volume, and the second joint may have a second volume wherein the second persistent organic matrix material is in a range of 3-5% of the second volume. Further, the first conductive material may be in a range of 95-97% of the first volume and the second conductive material may be in a range of 95-97% of the second volume. The first persistent organic matrix material and the second persistent organic matrix material may be an epoxy. The first joint and the second joint may have a thermal conductivity in a range of 25 W/mK to 100 W/mK.

In an additional aspect of the present disclosure, the photonic package assembly may further comprise a thermal stack mounted onto the heat sink mounting surface of the heat sink with a third joint, a photodiode mounted to the second mounting surface of the thermoelectric cooler, an optical driver circuit transmitting data signals to the optical modulator, and a transimpedance amplifier circuit receiving signals from the photodiode and transmitting signals to the electrical interconnect. The third joint may have a third volume, and may comprise a third persistent organic matrix material in a range of 3-5% of the third volume and a third conductive material in a range of 95-97% of the third volume. The third persistent organic matrix material may be an epoxy.

In an additional aspect of the present disclosure, the thermal stack may comprise an upper heat sink and a lower heat sink, where the lower heat sink has a lower heat sink mounting surface and the upper heat sink is mounted to the lower heat sink mounting surface by a fourth joint. The fourth joint may have a fourth volume, and may comprise a fourth persistent organic matrix material in a range of 3-5% of the fourth volume and a fourth conductive material in a range of 95-97% of the fourth volume. The fourth persistent organic matrix material may be an epoxy.

The first mounting surface of the thermoelectric cooler may have an area in a range of 100 mm² to 150 mm². Thus, the first joint may occupy an area in a range of 100 mm² to 150 mm². Each of the first joint, second joint, third joint, and the fourth joint may also have a thickness. The thickness of the first joint, second joint, third joint, and the fourth joint may be in a range of 25 μm-50 μm.

A method of creating a thermomechanical joint according to the present disclosure may comprise dispensing a volume of joint material via a dispensing tool onto a surface, such as a heat sink mounting surface. The volume of the joint material may correspond to an area of 100 mm² to 150 mm² and thickness of 25 μm-50 μm. A component to be connected to the surface, such as the TEC may then be placed in a desired position on top of the joint material. The joint material may then be cured at a temperature in a range of 150° C. and 200° C. for a time period in a range of 30 minutes to 3 hours to create the thermomechanical joint and bond the component to the surface. The curing process may take place in an open environment such as ambient air. This method is specifically described for forming the first joint, described above. This method can also be used for forming the second joint, third joint and the fourth joint by dispensing the volume of joint material onto an appropriate surface, placing a desired component onto the appropriate surface and then curing the joint material in a range of 150° C. and 200° C. for a time period in a range of 30 minutes to 3 hours.

The details of one or more implementations of the subject matter of this specification are set forth in the accompanying drawings and the description below. Other aspects, features, and advantages will become apparent from the description, the drawings, and the claims.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIG. 1 is a block diagram of an exemplary implementation of a transport network constructed in accordance with the present disclosure;

FIG. 2 is a diagram of an exemplary implementation of a computer system shown in FIG. 1 and constructed in accordance with the present disclosure;

FIG. 3 is a block diagram of an exemplary implementation of a network element being a muxponder constructed in accordance with the present disclosure;

FIG. 4 shows a photonic package assembly of an optical transceiver consistent with an aspect of the present disclosure;

FIG. 5 shows a perspective view of an example of a photonic package assembly consistent with an aspect of the present disclosure;

FIG. 6a shows a first example of a photonic package assembly consistent with an aspect of the present disclosure;

FIG. 6b shows a second example of a photonic package assembly consistent with an aspect of the present disclosure (put a cross-sectional line going from to back on this);

FIG. 7 shows a cross-sectional view of the photonic package assembly shown in FIG. 6b consistent with an aspect of the present disclosure and taken along the lines 7-7 in FIG. 6b; and

FIG. 8 shows an illustration of a thermomechanical joint consistent with an aspect of the present disclosure.

### DETAILED DESCRIPTION

The following detailed description refers to the accompanying drawings. The same reference numbers in different drawings may identify the same or similar elements.

The mechanisms proposed in this disclosure circumvent the problems described above. The present disclosure describes a photonic package assembly of an optical transceiver comprising at least one high-conductivity thermomechanical joint. The exemplary embodiment comprises a high-conductivity thermomechanical joint comprising conductive material dispersed in a persistent organic matrix material.

If used throughout the description and the drawings, the following short terms have the following meanings unless otherwise stated:

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

Further, the phrase “based on” is intended to mean “based, at least in part, on” unless explicitly stated otherwise.

Also, certain portions of the implementations have been described as “circuitry” that perform one or more functions. The term “circuitry” may include hardware, such as a processor, an application specific integrated circuit (ASIC), or a field programmable gate array (FPGA), or a combination of hardware and software. Software includes one or more computer executable instructions that when executed by one or more processor cause the processor to perform a specified function. It should be understood that the algorithms described herein are stored on one or more non-transitory memory. Exemplary non-transitory memory includes random access memory, read only memory, flash memory or the like. Such non-transitory memory can be electrically based or optically based. Further, the messages described herein may be generated by the circuitry and result in various physical transformations.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

In accordance with the present disclosure, messages transmitted between nodes can be processed by circuitry within the input interface(s), and/or the output interface(s) and/or the control module. Circuitry could be analog and/or digital, or one or more suitably programmed microprocessors and associated hardware and software, or hardwired logic. The term “circuitry,” may include hardware, such as a processor, an application specific integrated circuit (ASIC), or a field programmable gate array (FPGA), or a combination of hardware and software. Software includes one or more computer executable instructions that when executed by a processor cause the processor to perform a specified function.

It should be understood that a network node can be implemented in a variety of manners including those shown and discussed in U.S. Patent Application No. 20090245289 entitled “Programmable Time Division Multiplexed Switching” the entire content of which is hereby incorporated herein by reference.

As discussed above, prior art solders may exhibit fracturing due to thermomechanical stresses or lead to movement of circuit components during reflow. The present disclosure addresses these deficiencies by providing a photonic package assembly comprising a semi-sintered thermomechanical joint of high thermal conductivity and mechanical robustness using a conductive material dispersed within a persistent organic matrix material, such as epoxy.

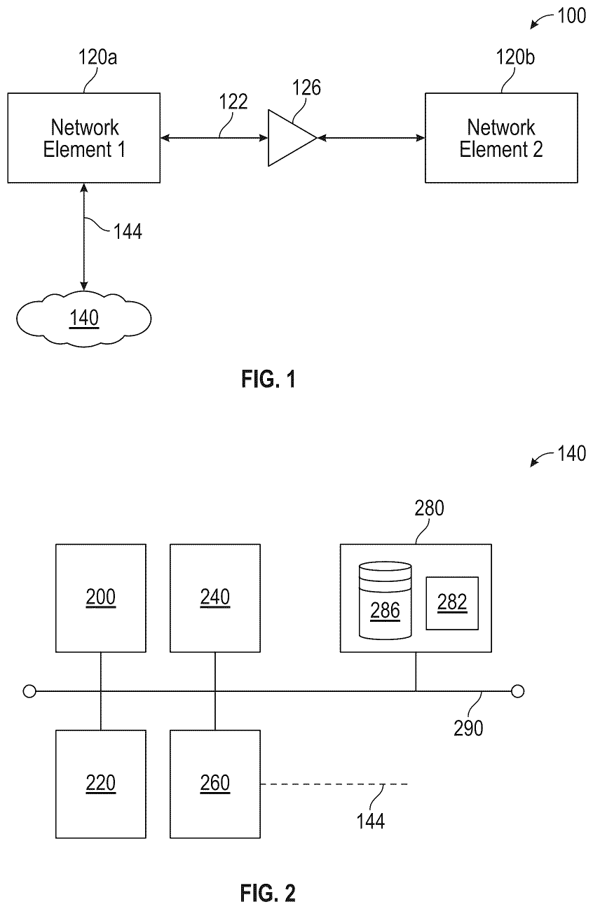

Referring now to the drawings, and in particular to FIG. 1, shown therein is a diagram of an exemplary implementation of a transport network 100 constructed in accordance with the present disclosure. The transport network 100 is depicted as having a plurality of network elements 120a-n, including a first network element 120a and a second network element 120b. Though two network elements 120 are shown for the purposes of illustration, it will be understood that the plurality of network elements 120a-n may comprise more or fewer network elements 120. Data transmitted within the transport network 100 may be transmitted along optical paths formed by a transmission line segment 122 (which may also be referred to as “media lane 122”). The transport network 10 may be provided with one or more optical in-line amplifiers (ILA) disposed in the transmission line segment 122 such as ILA 126. Though a single transmission line segment 122 is shown, it will be understood that the transport network 100 may comprise additional transmission line segments 122, such as between additional network elements 120.

In one implementation, a user may interact with a computer system 140, e.g., via a user device, that may be used to communicate with one or more of the network elements 120a-n (hereinafter “network element 120”) via a communication channel 144. Each element of the computer system 140 may be partially or completely network-based or cloud-based, and may or may not be located in a single physical location.

In some implementations, the computer system 140 is connected to one or more network element 120 via the communication channel 144. In this way, the computer system 140 may communicate with each of the one or more network element 120, and may, via the communication channel 144 transmit or receive data from each of the one or more network element 120. In other embodiments, the computer system 140 may be integrated into each network element 120 and/or may communicate with one or more pluggable card within the network element 120. In some embodiments, the computer system 140 may be a remote network element.

The communication channel 144 may permit bi-directional communication of information and/or data between the computer system 140 and/or the network elements 120 of the transport network 100. The communication channel 144 may interface with the computer system 140 and/or the network elements 120 in a variety of ways. For example, in some embodiments, the communication channel 144 may interface by optical and/or electronic interfaces, and/or may use a plurality of network topographies and/or protocols including, but not limited to, Ethernet, TCP/IP, circuit switched path, combinations thereof, and/or the like. The communication channel 144 may utilize a variety of network protocols to permit bi-directional interface and/or communication of data and/or information between the computer system 140 and/or the network elements 120.

The communication channel 144 may be a network connection. For example, in some embodiments, the communication channel 144 may be a version of an Internet network (e.g., exist in a TCP/IP-based network). In one embodiment, the communication channel 144 is the Internet. It should be noted, however, that the communication channel 144 may be almost any type of network and may be implemented as the World Wide Web (or Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, combinations thereof, and/or the like.

If the communication channel 144 is the Internet, a primary user interface of the computer system 140 may be delivered through a series of web pages or private internal web pages of a company or corporation, which may be written in hypertext markup language, JavaScript, or the like, and accessible by the user. It should be noted that the primary user interface of the computer system 140 may be another type of interface including, but not limited to, a Windows-based application, a tablet-based application, a mobile web interface, a VR-based application, an application running on a mobile device, and/or the like. In one embodiment, the communication channel 144 may be connected to one or more of the user devices, computer system 140, and the network elements 120a-n.

The transport network 100 may be, for example, made up of interconnected individual nodes (that is, the network elements 120). The transport network 100 may include any type of network that uses light as a transmission medium. For example, the transport network 100 may include a fiber-optic based network, an optical transport network, a light-emitting diode network, a laser diode network, an infrared network, a wireless optical network, a wireless network, combinations thereof, and/or other types of optical networks.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of the transport network 10 may perform one or more functions described as being performed by another one or more of the devices of the transport network 100. Devices of the computer system 140 may interconnect via wired connections, wireless connections, or a combination thereof. For example, in one embodiment, the user device and the computer system 140 may be integrated into the same device, that is, the user device may perform functions and/or processes described as being performed by the computer system 140, described below in more detail.

Referring now to FIG. 2, shown therein is a diagram of an exemplary embodiment of the computer system 140 constructed in accordance with the present disclosure. In some embodiments, the computer system 140 may include, but is not limited to, implementations as a pluggable computer housed in a network chassis, a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like.

In some embodiments, the computer system 140 may include one or more input devices 200 (hereinafter “input device 200”), one or more output devices 220 (hereinafter “output device 220”), one or more processors 240 (hereinafter “processor 240”), one or more communication devices 260 (hereinafter “communication device 260”) capable of interfacing with the communication channel 144, one or more non-transitory processor-readable medium (hereinafter “computer system memory 280”) storing processor-executable code and/or software application(s) 282, for example including, a web browser capable of accessing a website and/or communicating information and/or data over a wireless or wired network (e.g., the communication channel 144), and/or the like, and a database 286. The input device 200, the output device 220, the processor 240, the communication device 260, and the computer system memory 280 may be connected via a path 290 such as a data bus that permits communication among the components of the computer system 140.

In some implementations, the processor 240 may comprise one or more processor 240 working together, or independently, to read and/or execute processor executable code and/or data, such as stored in the computer system memory 280. The processor 240 may be capable of creating, manipulating, retrieving, altering, and/or storing data structures into the computer system memory 280. Each element of the computer system 140 may be partially or completely network-based or cloud-based, and may or may not be located in a single physical location.

Exemplary implementations of the processor 240 may include, but are not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The processor 240 may be capable of communicating with the computer system memory 280 via the path 290 (e.g., data bus). The processor 240 may be capable of communicating with the input device 200 and/or the output device 220.

The processor 240 may be further capable of interfacing and/or communicating with the network elements 120 via the communication channel 144 using the communication device 260. For example, the processor 240 may be capable of communicating via the communication channel 144 by exchanging signals (e.g., analog, digital, optical, and/or the like) via one or more ports (e.g., physical or virtual ports) using a network protocol to provide information to the one or more network element 120.

The computer system memory 280 may store a software application 282 that, when executed by the processor 240, causes the computer system 140 to perform an action such as communicate with, or control, one or more component of the computer system 140, the transport network 100 (e.g., the one or more network element 120a-n), and/or the communication channel 144.

In some implementations, the computer system memory 280 may have a data store that may store data such as network element version information, firmware version information, sensor data, system data, metrics, logs, tracing, and the like in a raw format as well as transformed data that may be used for tasks such as reporting, visualization, analytics, signal routing, power loading operations and/or coordination, etc. The data store may include structured data from relational databases, semi-structured data, unstructured data, time-series data, and binary data. The data store may be a data base, a remote accessible storage, or a distributed filesystem. In some embodiments, the data store may be a component of an enterprise network.

In some implementations, the computer system memory 280 may be located in the same physical location as the computer system 140, and/or one or more computer system memory 280 may be located remotely from the computer system 140. For example, the computer system memory 280 may be located remotely from the computer system 140 and communicate with the processor 240 via the communication channel 144. Additionally, when more than one computer system memory 280 is used, a first computer system memory may be located in the same physical location as the processor 240, and additional computer system memory may be located in a location physically remote from the processor 240. Additionally, the computer system memory 280 may be implemented as a “cloud” non-transitory processor-readable storage memory (i.e., one or more of the computer system memories 280 may be partially or completely based on or accessed using the communication channel 144).

In one implementation, the database 286 may be a time-series database, a relational database or a non-relational database. Examples of such databases comprise, DB2®, Microsoft® Access, Microsoft® SQL Server, Oracle®, mySQL, PostgreSQL, MongoDB, Apache Cassandra, InfluxDB, Prometheus, Redis, Elasticsearch, TimescaleDB, and/or the like. It should be understood that these examples have been provided for the purposes of illustration only and should not be construed as limiting the presently disclosed inventive concepts. The database 286 can be centralized or distributed across multiple systems.

The input device 200 may be capable of receiving information input from the user, another computer, and/or the processor 240, and transmitting such information to other components of the computer system 140 and/or the communication channel 144. The input device 200 may include, but is not limited to, implementation as a keyboard, a touchscreen, a mouse, a trackball, a microphone, a camera, a fingerprint reader, an infrared port, a slide-out keyboard, a flip-out keyboard, a cell phone, a PDA, a remote control, a fax machine, a wearable communication device, a network interface, combinations thereof, and/or the like, for example.

The output device 220 may be capable of outputting information in a form perceivable by the user, another computer system, and/or the processor 240. For example, implementations of the output device 220 may include, but are not limited to, a computer monitor, a screen, a touchscreen, a speaker, a website, a television set, a smart phone, a PDA, a cell phone, a fax machine, a printer, a laptop computer, a haptic feedback generator, a network interface, combinations thereof, and the like, for example. It is to be understood that in some exemplary embodiments, the input device 200 and the output device 220 may be implemented as a single device, such as, for example, a touchscreen of a computer, a tablet, or a smartphone. It is to be further understood that as used herein the term “user” is not limited to a human being, and may comprise a computer, a server, a website, a processor, a network interface, a user terminal, a virtual computer, combinations thereof, and/or the like, for example.

In general, the network element 120 transmits and receives data traffic and control signals. Nonexclusive examples of implementations of the network element 120 include a muxponder, optical line terminals (OLTs), optical cross connects (OXCs), optical line amplifiers, optical add/drop multiplexer (OADMs) and/or reconfigurable optical add/drop multiplexers (ROADMs), interconnected by way of optical fiber links.

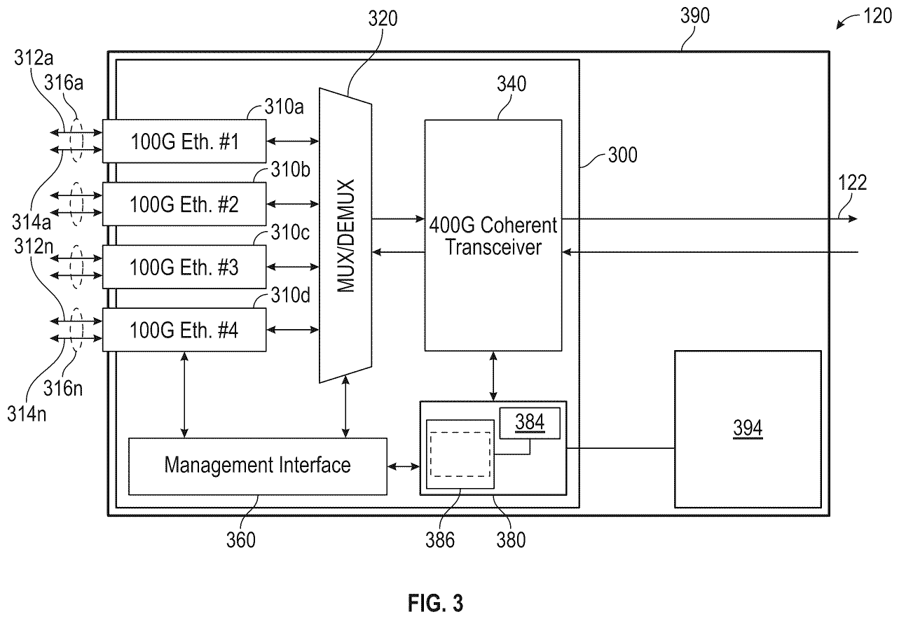

Referring now to FIG. 3, shown therein is a block diagram of an exemplary implementation of the network element 120 constructed in accordance with the present disclosure. In the implementation illustrated in FIG. 3, the network element 120 may be, or may be provided with, a muxponder 300. The muxponder 300 may be configured to aggregate multiple electrical network services, such as Ethernet, SONET/SDH, Fiber Channel, HD/SD-SDI, OTU2/3/4, etc., into an optical signal or signals. The muxponder 300 may be provided with a plurality of electrical ports 310a-n (illustrated for exemplary purposes as a first electrical port 310a, a second electrical port 310b, a third electrical port 310c, and a fourth electrical port 310d), each of the electrical ports 310a-310n having an associated first electrical register 312a-n (which may also be referred to as a first host lane or host lane 1, only one of which is labeled in FIG. 3 for clarity) and a second electrical register 314a-n (which may be referred to as a second host lane or host lane 2, only one of which is labeled in FIG. 3 for clarity), the associated first electrical register 312a-n and second electrical register 314a-n as a pair may be referred to as a host lane group and are assigned a hub identification code 316a-316n (referred to herein as hub-client-ID 316a-316n). It should be noted, however, that other terms besides “hub identification” and/or “hub-client-ID” may be used to identify host lanes and/or host lane groups. For instance, in some implementations, “cross-connect identification” and/or “cross-connect ID” may be used. In some implementations, “service identification” and/or “service ID” may be used on one side of a transmission line segment and “cross-connect identification” and/or “cross-connect ID” may be used on the other side of the transmission line segment.

In some implementations, the muxponder 300 may further comprise a multiplexer/demultiplexer 320, an optical transceiver 340, a management interface 360, and/or a controller 380. The controller 380 may be provided with a mux processor 384 and non-transitory computer readable memory 386 (hereinafter “mux memory 386”).

The mux processor 384 executes an application stored in mux memory 386 may become a special-purpose machine particularly suited for performing various actions, operations, analyses, and/or the like in accordance with the systems and methods described herein.

In the illustrated implementation, the electrical ports 310a-310n are shown each having a 100-gigabit capacity. In such an implementation, each of the first electrical register 312a-n and the second electrical register 314a-n would have a 50-gigabit capacity. An exemplary implementation of the electrical ports 310a-310n includes, but is not limited to implementation as a 100GAUI-2 electrical interface that may be part of a pluggable 400 g module.

The muxponder 300 may be hardwired and/or programmed to receive electrical data signals via the electrical ports 310a-310n (which may be referred to as a “host side”), aggregate or multiplex the data signals in the multiplexer/demultiplexer 320, and transmit an optical signal containing the aggregated data via the optical transceiver 340 over the transmission line segment 122 (which may be referred to as a “media side”). The optical transceiver 340 may be provided with a local oscillator laser, optical hybrids, and photodiodes that operate in a known manner to provide electrical signals to an ADC (which may be included in an ASIC), which, in turn, provides digital signals or samples to a DSP. A transmission side of the optical transceiver 340 may be provided with modulators, modulator driver circuitry, and lasers. The DSP may include DAC circuits that convert digital signals from the DSP into analog signals, which are supplied to the modulator driver circuitry.

In some implementations, the network element 120 may be a chassis system 390 and the muxponder 300 may be a line card inserted in or part of the chassis system 390. The chassis system 390 may be provided with a controller 394 which may be comprised of similar elements as computer system 140.

In FIG. 3, the muxponder 300 is illustrated as a 400-gigabit module having four 100 gigabit electrical ports 310a-310d. However, is should be noted that in other implementations, the muxponder 300 may be provided having any capacity. For instance, the muxponder 300 may be an 800-gigabit module having eight electrical ports 310 with each electrical port 310 having a 100-gigabit capacity. In another exemplary implementation, the muxponder 300 may be an 800-gigabit module having five electrical ports 310 with four of the electrical ports having a 100-gigabit capacity and one of the electrical ports having a 400-gigabit capacity.

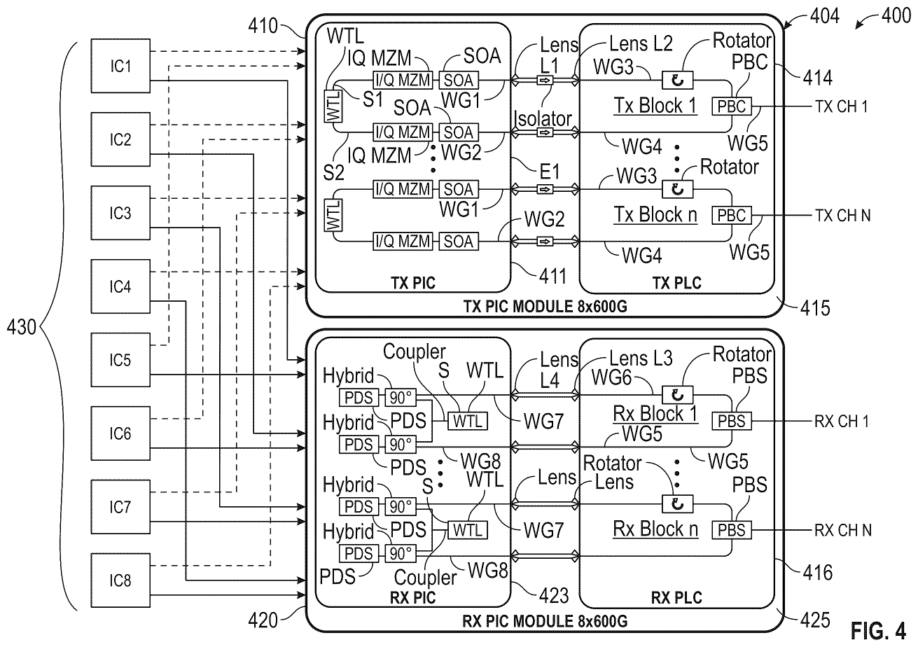

The optical transceiver 340 of the muxponder 300 may be provided as photonic package assembly such as one shown in FIGS. 4-7. There are many configurations of photonic package assemblies which are consistent with the present disclosure, and FIGS. 4-7 are merely examples of configurations consistent with this disclosure.

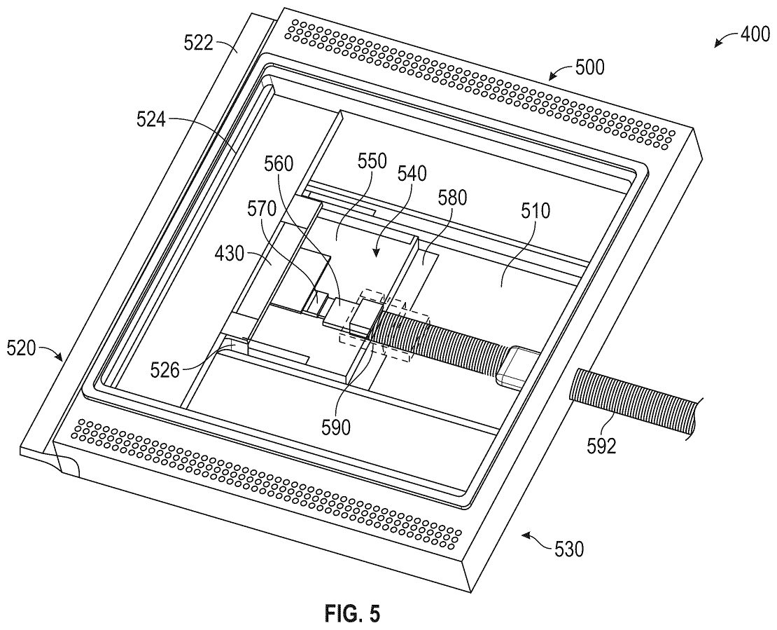

Turning to FIG. 4, this diagram shows an exemplary block diagram of a photonic package assembly 400 of the optical transceiver 340 consistent with the present disclosure. In this example, the photonic package assembly 400 shown in FIG. 4 includes a photonic device 404 including separate Tx (transmit) and Rx (receive) photonic integrated circuits (“PICs”) provided in Tx PIC module (410) and Rx PIC module (420). As noted above, however, the Tx and Rx PICs may be provided on one PIC substrate as a transceiver photonic integrated circuit or “transceiver PIC” (FIG. 5, 540) with a laser used as both an optical source and a local oscillator or with two separate lasers in the Rx and Tx portions of the transceiver PIC 540. The transceiver may comprise a plurality of transmitter channels Tx Ch 1 to Tx Ch n. Tx Ch 1 and Tx Ch n are shown in FIG. 4 as having the same or similar structure and including the same or similar devices. The modulated optical signal output from Tx Ch 1, however, may have a first wavelength and the optical signal output from Tx Ch n may have a second wavelength different from the first wavelength. Moreover, each of optical channels Tx Ch 1 to Tx Ch n supplies a corresponding one of a plurality of modulated optical signals, each having a corresponding one of a plurality of wavelengths.

A driver circuit, which may be provided in an integrated circuit (such as one of ICs IC1 to IC8), which may include an application specific integrated circuit (ASIC) or a digital signal processor (DSP) may provide radio frequency (RF) drive signals corresponding to the transmitted data to modulators provided in channel Tx Ch 1 on the Tx PIC. The modulators may receive light from a widely tunable laser (WTL). In addition, the modulators may include Mach Zehnder (MZ) modulators (labeled IQ MZM in FIG. 4) having a nested pair configuration in which a first nest pair of MZ modulators receives light output (a first portion of light output from laser WTL) from one side S1 or facet of the WTL and a second pair of MZ modulators receives light output (a second portion of light output from laser WTL) from the second side S2 or facet of the WTL.

A first MZ modulator of the first pair may modulate part of a first portion the received light from the first side S1 of the WTL in accordance with selected radio frequency (RF) drive signals to provide a first in-phase component of the modulated optical signal and the second MZ modulator of the pair may modulate another part of the first portion of the received light from the first side S1 of the WTL in accordance with other RF drive signals to provide a first quadrature component of the modulated optical signal. Similarly, light output from the second side S2, a second portion of the light output from the WTL, is modulated based on additional RF drive signals supplied to a second IQ MZM to provide second in-phase and quadrature components of another modulated optical in accordance with additional drive signals. As further shown in FIG. 4, light output from each of IQ MZMs in Tx Ch 1 is provided to a corresponding optional semiconductor optical amplifier (SOA) to amplify such light and offset optical losses incurred during modulation and propagation along Tx Ch 1.

Light output from both sides of the WTL has a transverse electric (TE) polarization. In order to further increase capacity of the transmitted optical signal and to minimize interference between the outputs of the IQ MZMs, light output from the first IQ MZM is supplied from the Tx PIC on respective waveguides WG that extend to an edge of Tx PIC substrate 411. Such light may be directed toward a waveguide on a planar lightwave circuit (Tx PLC) by a pair of lenses L1 and L2 (such as silicon lenses) and an isolator provided between the lenses. Lens L1 may be a collimating lens and lens L2 may be a focusing lens that focuses the optical signals onto corresponding waveguides in Tx Block 1 to n of the Tx PLC (planar lightwave circuit) on Tx PLC substrate 414.

Both the Tx PLC substrate 414 and the Tx PIC substrate 411 may be provided on a third substrate or Tx interposer substrate 415, which may also include a substrate made of silicon or a dielectric, such as silicon dioxide. The Tx or Rx PLC may include a substrate made of silicon or a dielectric, such as silicon dioxide, and the devices provided on the PLC may be silicon-based. For example, as shown in FIG. 4, a rotator may be provided on the Tx PLC to rotate the polarization of modulated light from the first IQ MZM from a TE polarization to a transverse magnetic (TM) polarization that is preferably orthogonal to the TE polarization. The TE polarization of light from the second IQ MZM, however, is maintained, and the TM polarized light is combined with the TE polarized light in a polarization beam combiner (PBC) provided on the Tx PLC. The PBC, in turn, provides a polarization multiplexed output having a first wavelength on a corresponding waveguide WG5. The WTL, IQ MZMs, SOA, isolator, lenses, rotator, and PBC may collectively be referred to herein as a Tx Block 1, which, as further shown in FIG. 4, is part of Tx Ch 1. Tx Block 2 to n may have the same or similar structure as Tx Block 1 and may similarly provide corresponding polarization multiplexed outputs, each of which having a respective one of a plurality of wavelengths. Thus, by polarization multiplexing the TE and TM signals, capacity can be increased compared to transmission of signals having a single polarization.

The rotators shown in FIG. 4 may be arranged in a first array and the polarization beam splitters may be arranged in a second array. In addition, the polarization beam combiners may be arranged in an array.

The output of the Tx Block 1 may be provided to a variable optical attenuator (VOA) to selectively attenuate the received polarization multiplexed optical signal to have desired power level. Optical taps provided at the input and output of the VOA may be provided to tap off a small portion of the received light and supply such portions to corresponding photodiodes. The photodiodes, in turn, convert the received light portions to corresponding electrical signals which are fed to additional circuitry that can monitor the power, for example, of light input to and output from the VOA.

Thus, FIG. 4 shows an optical device, such as Tx PIC module 410 including substrate 411 upon which the TX PIC may be provided. Tx PIC substrate 411 may be made of a Group III-V material and may include indium phosphide (InP) or gallium arsenide (GaAs). Alternatively, Tx PIC substrate 411 may include silicon. 2N (N being integer) outputs may be provided on the Tx PIC substrate 411, each of which including a respective one of 2N waveguides (WG1 and WG2), each of the 2N waveguides (WG1 and WG2) carries a respective one of 2N optical signals, such that the 2N waveguides may be outputs of Tx PIC substrate 411. Each of the 2N optical signals including an in-phase component and a quadrature component, and each of the 2N waveguides extending to edge E1 of Tx PIC substrate 411. N lasers (WTL) are also provided on Tx PIC substrate 411, and each of first N waveguides (WG1) of the 2N waveguides being optically coupled to a respective one of the N lasers (WTL). Each of the first N waveguides WG1 supplies a first portion of the light generated by a respective one of the N lasers (WTL) and may be provided to a corresponding one of N semiconductor optical amplifiers (SOAs) via a corresponding modulator MZM IQ.

As further shown in FIG. 4, each of second N waveguides (WG2) is optically coupled to a respective one of the N lasers (WTL), such that each waveguide WG2 supplies a second portion of the light generated by a respective one of the WTL lasers to a corresponding one of another group of N SOAs via a respective modulator MZM IQ.

Tx PIC Module 410 further includes a Tx PLC substrate 414 having third N (N being equal to n above) waveguides WG3, each of which being optically coupled to a corresponding one of the first N waveguides WG1 via collimating lens L1, an isolator, and a focusing line L2. The third N waveguides WG3 are provided on second substrate 1020. In addition, fourth N waveguides WG4 are provided on Tx PLC substrate 414. Each of fourth waveguides WG4 is optically coupled to a corresponding one of the second N waveguides WG2 via a corresponding collimating lens L1, an additional isolator, and a focusing lens L2. The fourth N waveguides WG4 are also provided on the second substrate.

Tx PLC substrate 414 may further include a plurality (N) of polarization elements, such the rotators and associated polarization beam combiners (PBCs) shown in FIG. 4. Each PBC has a first port optically coupled to a respective one of waveguides WG3, a second port optically coupled to a respective one of waveguides WG4, and a third port that connects to a corresponding fifth waveguide WG5.

In the example shown in FIG. 4, light output from sides S1 and S2 of each laser or WTL is modulated by a corresponding nested Mach-Zehnder modulator IQ MZM. Consistent with an additional aspect of the present disclosure, however, light may be output from one slide of the laser (WTL) may be provided to a power splitter having first and second outputs. The first output supplies a first portion of the light output from the laser to a first IQ MZM and a portion of the light output from laser is provided from a second output of the splitter.

Each laser may be tunable. In one example, each of the N lasers is a widely tunable laser that is tunable over a 35 nm range of wavelengths between 1460 nm and 1625 nm. In another example, each of the N lasers is a widely tunable laser that is tunable over a 17.5 nm range of wavelengths between 1460 nm and 1625 nm. Alternatively, each laser may be a distributed feedback (DFB) laser that is tunable over a 2 nm range of wavelengths between 1460 nm and 1625 nm or a widely tunable laser having a grating.

Received optical signals are provided to Rx PLC substrate 416 in the example shown in FIG. 4 of Rx PIC Module 420. Each fiber may carry one or more polarization multiplexed optical signals (e.g., N). A plurality, e.g., N polarization elements, such as polarization beam splitter (PBS) may be provided on Rx PLC substrate 416. Each such PBS has a first output that supplies a TE component (itself an optical signal) to waveguide WG5 and a second output that supplies a TM component (itself also an optical signal) of a respective one of received polarization multiplexed optical signals (e.g., N polarization multiplexed optical signals). The TM component is provided to a corresponding one of a plurality (e.g., N) polarization rotators on Rx PLC substrate 416. Each rotator rotates a polarization of the received TM component (optical signal) such that the signal output from each rotator has a TE polarization. The rotated optical signals are supplied to a corresponding one of waveguides WG6.

Respective waveguide WG6 supplies a corresponding one of the rotated optical signals (N such signals) to a corresponding one of waveguides WG7 (inputs, for example) via collimating lens L3 and focusing lens L4. Similarly, respective waveguide WG5 supplies a corresponding one of the TE optical signals (N such signals) to a corresponding one of waveguides WG8 via another collimating lens L3 and another focusing lens L4.

Waveguides WG7 and WG8 (inputs of the RX PIC substrate) supply respective optical signals to corresponding optical hybrid circuits, which in this example are 90-degree optical hybrid circuits. Each optical hybrid circuit receives first and second power split portion of light output from a side S of a local oscillator laser (WTL). The first and second power split portions are provided from first and second outputs, respectively, of a coupler or splitter coupled to side S of the local oscillator laser WTL.

The received optical signals from waveguides WG7 and WG8 are mixed with light from local oscillator lasers (WTL) in the optical hybrid circuits. The optical hybrids, in turn, supply groups of mixing products to groups of photodiodes. In the example shown in FIG. 4, N local oscillator lasers are associated with 2N optical hybrid circuits and 2N groups of photodiodes (PDs). The local oscillator lasers, optical hybrids circuits, and photodiode groups may be provided on substrate 1013 (also referred to herein as a PIC substrate or an RX PIC substrate), which may include a Group III-V material, such as InP or GaAs, or silicon. Rx PLC substrate 416 may also be provided in Rx PIC module 412 and both the Rx PIC substrate 423 and the Rx PLC substrate 416 may be provided on an Rx interposer substrate 425, similar to or the same as Tx interposer substrate 415 noted above.

The groups of photodiodes generate radio frequency (RF) signals that are fed to corresponding ones of integrated circuits (“ICs”) 430. The ICs 430 may include transimpedance amplifiers (TIAs), analog to digital converters (ADCs) and carrier recover circuitry.

Turning to FIG. 5, an embodiment of a photonic package assembly 400 is depicted consistent with the present disclosure. The photonic package assembly 400 has a top, bottom, and perimeter defined by a container 500. The container 500 may be hermetically sealed. The container 500 may be comprised of any suitable metal or material. A base portion 510 of the container 500 may be configured as a heat sink 510, and thus may be comprised of a material with sufficiently high thermal conductivity such as Ag, Au, Cu, Al, and CuW. The heat sink 510 serves to dissipate heat generated within the sealed container 500 to the environment outside the container 500.

The container 500 may further have a first side 520 and a second side 530 which opposes the first side 520. In the configuration shown in FIG. 5, the first side 520 may be an electrical side 520 and the second side may be an optical side 530. On the electrical side 520, an RF I/O shelf 522 may define an outermost edge of the electrical side 520. The RF I/O shelf 522 manages external signals entering and exiting the photonic package assembly 400. The RF I/O shelf 522 may transmit/receive electrical signals to/from a computer processor (not shown). The RF I/O shelf 522 may comprise all necessary components to establish signal communication with an external source.

The RF I/O shelf 522 may further be in signal communication with an internal RF fanout 524 comprised within the container 500. The internal RF fanout 524 may receive electrical signals from the RF I/O shelf 522 and/or the ICs 430 (hereafter “application specific integrated circuit(s) 430” or “ASIC 430”) and distribute the signals to other components of the photonic package assembly 400.

As described previously, the ASIC 430 may comprise a number of integrated circuits for electrical-to-optical and optical-to-electrical signal conversion, such as optical modulator drivers like Mach-Zehnder-Modulator drivers (“MZMDs”), transimpedance amplifiers (“TIAs”), carrier recover circuitry, and analog to digital converters (“ADCs”). The ASIC 430 may be bonded by a thermomechanical joint to a thermal stack 526. The thermal stack 526 may be bonded by a thermomechanical joint to the heat sink 510. The thermal stack 526 may serve to regulate the temperature of the ASIC 430 by transferring heat from the ASIC 430 to the heat sink 510.

As described above and as shown in FIG. 4, the ASIC 430 may be in signal communication with the Tx PIC module 410, and the Rx PIC module 420, or both in the form of a transceiver PIC module 540. The transceiver PIC module 540 may comprise a transceiver PIC 550 with photonic devices such as widely-tunable lasers, photonic modulators like Mach-Zender modulators, and photodiodes; a transceiver PLC 560 comprising light-manipulators like PBSs, PBCs, and rotators; and a PIC optics module 570 disposed between the transceiver PLC 560 and the transceiver PIC 550 comprising lensing and collimating devices for directing light to/from the transceiver PIC 550 from/to the transceiver PLC 560.

The transceiver PIC module 540 may be mounted via a thermomechanical joint to the upper side of a thermoelectric cooler 580. The thermoelectric cooler 580 (hereafter “TEC 580”) may be mounted on its lower side to the heat sink 510 via a thermomechanical joint. The TEC 580 may be capable of regulating the temperature of the transceiver PIC 550 by transferring heat either from the transceiver PIC module 540 to the heat sink 510, or transferring heat from the heat sink 510 to the transceiver PIC module 540. In one implementation, the TEC 580 may maintain the transceiver PIC module 540, and all components comprised thereof such as lasers, in a temperature range of 10° C. to 70° C., or more particularly 20° C. to 60° C.

The TEC 580 may be any size necessary, but may be sufficiently large to accommodate mounting of the transceiver PIC module 540 and, in some implementations, other components such as an optical interconnect 590. By way of example but not limitation, the largest 2-dimensional area of the TEC 580 may be on the order of 100 mm² to 150 mm².

As noted above, an optical interconnect 590 may also be mounted on the upper surface of the TEC 580 adjacent to the transceiver PIC module 540. The optical interconnect 590 may comprise connecting, lensing, and focusing devices capable of directing light from optical fibers 592 to the optical devices of the photonic package assembly 400. Thus, extending from the optical interconnect 590 and out of the container 500 on the optical side 530 may be a plurality of optical fibers 592. The plurality of optical fibers 592 may connect outside of the photonic package assembly 400 in a number of ways as part of transport network 100.

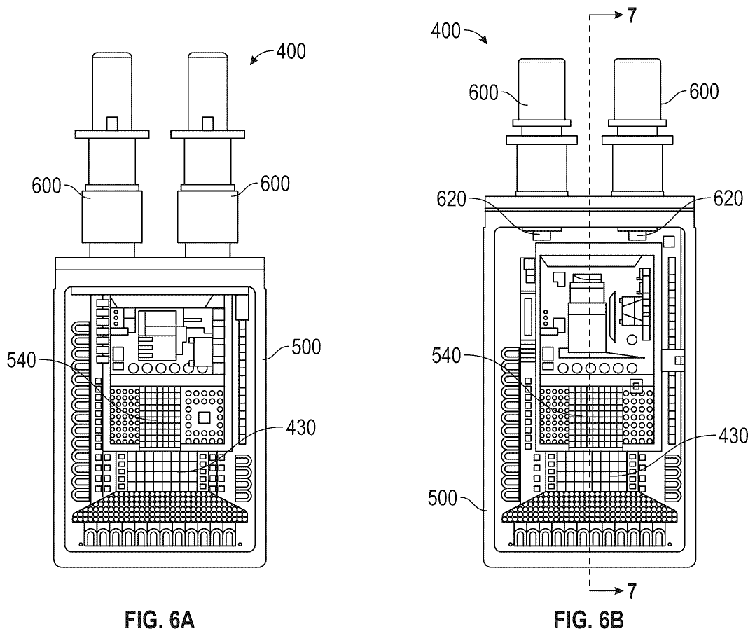

Turning now to FIGS. 6a and 6b, two implementations of a photonic package assembly 400 consistent with the present disclosure are shown. In these implementations, optical fibers 592 are housed within a duality of optical fiber receptacles 600. These optical fiber receptacles 600 may permit rapid connect and disconnect of photonic package assemblies 400 from the larger transport network 100, allowing for ease of replacement and modularity. In one implementation, shown in FIG. 6a, the optical fiber receptacles 600 comprise all necessary fiber lensing within the optical fiber receptacles 600 for optical communication with the photonic package assembly 400. In another implementation as shown in FIG. 6b, optical fiber lenses 620 are housed within the container 500 of the photonic package assembly 400. The optical fiber lenses 620 may be aligned with a longitudinal n axis of each optical fiber receptacle 600.

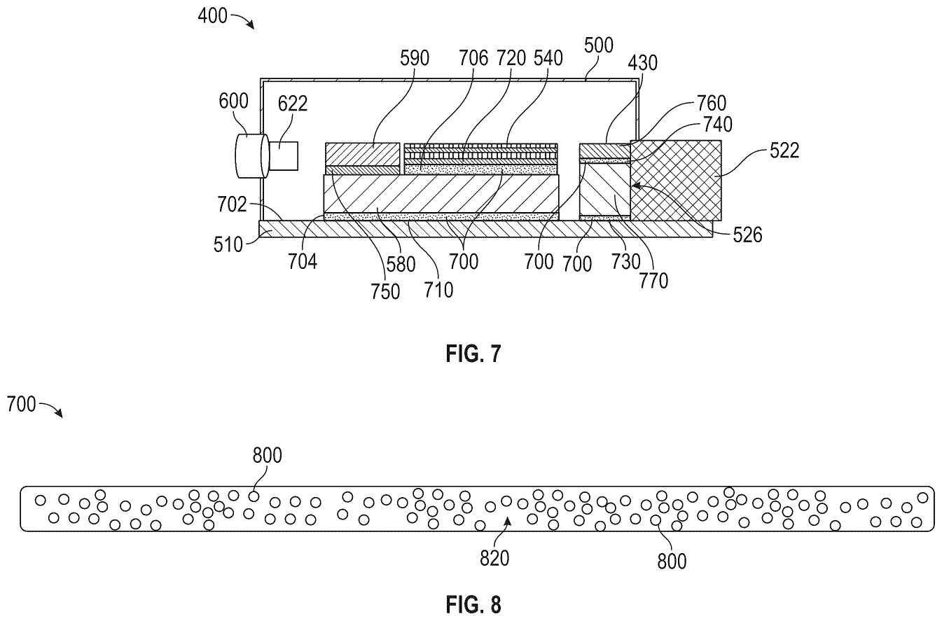

FIG. 7 is a cross-sectional depiction of the photonic package assembly 400 shown in FIG. 6b and constructed in accordance with the present disclosure. As shown, the heat sink 510 may have a heat sink mounting surface 702 defined as a top surface of the heat sink 510. The TEC 580 may have a first mounting surface 704, which may be mounted to the heat sink 510 on the heat sink mounting surface 702 by means of a first joint 710. The TEC 580 may also have an upper TEC surface 706 which may be a second mounting surface 706. The transceiver PIC module 540 may be mounted to the TEC 580 on the second mounting surface 706 by means of a second joint 720. Additionally, the thermal stack 526 may be mounted to the heat sink mounting surface 702 of the heat sink 510 by means of a third joint 730. The first joint 710, the second joint 720, and the third joint 730 may be thermomechanical joints 700.

Turning to FIG. 8, an illustration of the thermomechanical joint 700 and the constituents thereof are shown. The depiction of the thermomechanical joint 700 shown in FIG. 8 is for illustrative purposes only and is not intended to be limiting as to shape, size, placement, volume, density, or amount of the thermomechanical joint 700 or any constituents thereof. Thermomechanical joints 700 may be semi-sintered joints comprising a conductive material 800 and a matrix material 820. The thermomechanical joints 700 may be constructed of a semi-sintering paste, such as LOCTITE® ABLESTIK ABP 8068TB comprised primarily of silver and to a lesser extent organic epoxy. In accordance with the present disclosure, the conductive material 800 may be any suitable conductive material such as, but not limited to, Ag, Au, Cu, and Al. The conductive material 800 may be particulate metals or metal powders dispersed throughout the matrix material 820. The conductive material 800 may have a volume in a range of 95%-97% of a volume of the thermomechanical joint 700.

The matrix material 820 may be a persistent organic matrix material supporting the conductive material 800 and capable of withstanding thermal excursions. In one implementation, the matrix material 820 may be a polymer such as an epoxy resin. The matrix material 820 may have a volume in a range of 3%-5% of the volume of the thermomechanical joint 700.

The thermomechanical joints 700 may have a sufficiently high thermal conductivity such that heat may be effectively transferred from transceiver PIC module 540 to the TEC 580, and from the TEC 580 to the heat sink 510. In one implementation, the thermomechanical joints 700 may have a thermal conductivity in a range of 25 W/mK to 100 W/mK.

Further, the thermomechanical joints 700 may be sufficiently ductile to withstand thermomechanical stresses. The TEC 580 typically has a temperature gradient from the second mounting surface 706, where the transceiver PIC module 540 is mounted, to the first mounting surface 704 mounted to the heat sink 510. This temperature difference causes bowing or deformation of the TEC 580, placing stresses on the thermomechanical joints 700. Thus, the thermomechanical joints 700 must be sufficiently ductile to maintain mechanical integrity throughout these deformations while being sufficiently ductile to be applied thinly over a wide area. In one implementation, a thickness of the thermomechanical joints 700 may be 25 μm-50 μm. In one implementation, the first joint 710 and the second joint 720 may occupy an area of 100 mm² to 150 mm².

Returning now to FIG. 7, the thermal stack 526 may be a singular heat sink mounted to the heat sink 510, or may be comprised of two or more heat sinks. In the implementation shown in FIG. 7, the thermal stack 526 may comprise an upper heat sink 760 and a lower heat sink 770. The lower heat sink 770 may be mounted to the heat sink 510 by the third joint 730, while the upper heat sink 760 may be mounted to the lower heat sink 770 by a fourth joint 740. The fourth joint 740 may be a thermomechanical joint 700, as described above. The ASIC 430 may be mounted to the upper heat sink 760 as shown.

The optical interconnect 590 may be mounted either to the heat sink 510, or to the TEC 580 on the second mounting surface 706 by a fifth joint 750. The fifth joint 750 may be an epoxy joint.

A method of creating the first joint 710 according to the present disclosure may comprise dispensing a volume of thermomechanical joint material 700 via a dispensing tool onto the heat sink mounting surface 702 of the heat sink 510. The thermomechanical joint material 700 may be a semi-sintering paste such as LOCTITE® ABLESTIK ABP 8068TB. The volume of the thermomechanical joint material 700 may correspond to an area of 100 mm² to 150 mm² and thickness of 25 μm-50 μm. The TEC 580 may then be placed in a desired position on top of the thermomechanical joint material 700. The thermomechanical joint material 700 may then be cured at a temperature in a range of 150° C. and 200° C. for a time period in a range of 30 minutes to 3 hours to create the first joint 710 and bond the TEC 580 to the heat sink 510. The curing process may take place in an open environment such as ambient air. Similarly for the second joint 720, thermomechanical joint material 700 may be dispensed onto the second mounting surface 706 of the TEC 580 in an area corresponding to a heat transfer area of the transceiver PIC module 540. The transceiver PIC module 540 may then be placed in a desired position on top of the TEC 580. The thermomechanical joint material 700 may then be cured at a temperature in a range of 150° C. and 200° C. for a time period in a range of 30 minutes to 3 hours to create the second joint 720 and bond the transceiver PIC module 540 to the TEC 580. The curing process may take place in an open environment such as ambient air.

The third joint 730 and fourth joint 740 may be formed in a method similar to the methods described for the first joint 710 and second joint 720 for their respective components. Forming each of the first joint 710, second joint 720, third joint 730, and fourth joint 740 may comprise dispensing the thermomechanical joint material 700 in a liquid state. The thermomechanical joint material 700 may form a solid as a result of the curing process, bonding two components rigidly together.

Stress testing of photonic package assemblies constructed in accordance with the present disclosure yielded surprising results. Twelve photonic package assemblies were constructed identically. Each photonic package assembly comprised a semi-sintered TEC-to-heat sink mounting surface thermomechanical joint. The thermomechanical joint had approximately an area of 107 mm² and a thickness of 35 μm.

In one test, the photonic package assemblies were cycled from −40° C. to 85° C. 100 cycles were performed and the thermomechanical joints between the TEC and the heat sink mounting surface were evaluated for mechanical failure. None of the twelve photonic package assemblies experienced mechanical failure in the thermomechanical joint between the TEC and the heat sink mounting surface.

In another test, the photonic package assemblies were stored at a temperature of 85° C. for 2000 hours. The photonic package assemblies were periodically checked for mechanical failure. None of the twelve photonic package assemblies experienced mechanical failure in the thermomechanical joint between the TEC and the heat sink mounting surface.

In another test, the photonic package assemblies were operated and the PIC module mounted onto the TEC was maintained at a temperature of 75° C. for 1000 hours. None of the twelve photonic package assemblies experienced mechanical failure in the thermomechanical joint between the TEC and the heat sink mounting surface.

In another test, the photonic package assemblies were stored in a damp heat environment at 85° C. and 85% relative humidity for 500 hours. None of the twelve photonic package assemblies experienced mechanical failure in the thermomechanical joint between the TEC and the heat sink mounting surface.

Because the semi-sintered joints have traditionally been used for small-die applications of up to 25 mm², it was expected that at least some of the photonic package assemblies tested would experience failure. The results indicating that no photonic package assemblies experienced failure throughout any test of the thermomechanical joint between the TEC and the heat sink mounting surface were therefore unexpected and surprising.

Other embodiments will be apparent to those skilled in the art from consideration of this specification. It is intended that this specification and the embodiments therein be considered as exemplary only.

### CONCLUSION

Conventionally, solders have been used in thermomechanical joints of photonic package assemblies. However, harder solders are prone to fracturing under thermomechanical stresses, while softer, more ductile solders may cause components to shift during reflow. In accordance with the present disclosure, a photonic package assembly is provided which comprises at least one and desirably multiple semi-sintered thermomechanical joint(s) which are sufficiently ductile to respond to thermomechanical stresses while permitting precise placement of components during manufacture.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A photonic package assembly, comprising:
a heat sink having a heat sink mounting surface;
a thermoelectric cooler having a first mounting surface and a second mounting surface, the first mounting surface mounted onto the heat sink mounting surface of the heat sink with a first joint having a first thermal conductivity of 25 W/mK to 100 W/mK, the first joint comprising:
a first persistent organic matrix material; and
a first conductive material dispersed within the first persistent organic matrix material; and
a laser mounted onto the second mounting surface of the thermoelectric cooler with a second joint having a second thermal conductivity of 25 W/mK to 100 W/mK, the second joint comprising:
a second persistent organic matrix material; and
a second conductive material dispersed within the second persistent organic matrix material; and
an optical interconnect mounted onto at least one of:
the heat sink mounting surface of the heat sink; or
the second mounting surface of the thermoelectric cooler;
an electrical interconnect; and
an optical modulator receiving data signals from the electrical interconnect and operable to modulate data signals into light generated by the laser.

2. The photonic package assembly of claim 1, wherein the first joint has a first volume, and wherein:
the first persistent organic matrix material is 3-5% of the first volume; and
the first conductive material is 95-97% of the first volume.

3. The photonic package assembly of claim 2, wherein the first persistent organic matrix material is an epoxy.

4. The photonic package assembly of claim 1, wherein the second joint has a second volume, and wherein:
the second persistent organic matrix material is 3-5% of the second volume; and
the second conductive material is 95-97% by volume of the second volume.

5. The photonic package assembly of claim 4, wherein the second persistent organic matrix material is an epoxy.

6. The photonic package assembly of claim 1, further comprising:
a thermal stack mounted onto the heat sink mounting surface of the heat sink with a third joint having a third thermal conductivity of 25 W/mK to 100 W/mK;
the third joint comprising:
a third persistent organic matrix material; and
a third conductive material dispersed within the third persistent organic matrix material;
a photodiode mounted to the second mounting surface of the thermoelectric cooler;
an optical driver circuit transmitting data signals to the optical modulator; and
a transimpedance amplifier circuit receiving signals from the photodiode and transmitting signals to the electrical interconnect.

7. The photonic package assembly of claim 6, wherein the third joint has a third volume, and wherein:
the third persistent organic matrix material is 3-5% of the third volume; and
the third conductive material is 95-97% of the third volume.

8. The photonic package assembly of claim 7, wherein the third persistent organic matrix material is an epoxy.

9. The photonic package assembly of claim 6, wherein the thermal stack comprises:
an upper heat sink; and
a lower heat sink having a lower heat sink mounting surface;
wherein the upper heat sink is mounted to the lower heat sink mounting surface by a fourth joint having a fourth thermal conductivity of 25 W/mK to 100 W/mK, the fourth joint having:
a fourth persistent organic matrix material; and
a fourth conductive material dispersed within the fourth persistent organic matrix material.

10. The photonic package assembly of claim 9, wherein the fourth joint has a fourth volume, and wherein:
the fourth persistent organic matrix material is 3-5% of the fourth volume; and
the fourth conductive material is 95-97% of the fourth volume.

11. The photonic package assembly of claim 10, wherein the fourth persistent organic matrix material is an epoxy.

12. The photonic package assembly of claim 1, wherein the laser is maintained in a temperature range of 10° C. to 70° C.

13. The photonic package assembly of claim 1, wherein the first mounting surface of the thermoelectric cooler has an area in a range of 100 mm² to 150 mm².

14. The photonic package assembly of claim 1, wherein the first joint occupies an area in a range of 100 mm² to 150 mm².

15. The photonic package assembly of claim 1, wherein at least one of the first joint and the second joint have a thickness of 25 μm-50 μm.

16. A method comprising:
mounting a first mounting surface of a thermoelectric cooler to a heat sink of a photonic package with a first joint having a first thermal conductivity in a first range of 25 W/mK to 100 W/mK, the first joint comprising a first persistent organic matrix material and a first conductive material dispersed within the first persistent organic matrix material.

17. The method of claim 16, wherein mounting the first mounting surface to the heat sink further comprises:
dispensing a first joint material onto a heat sink mounting surface of the heat sink;
placing the thermoelectric cooler onto the first joint material; and
curing the first joint material to form the first joint.

18. The method of claim 17 wherein:
the heat sink mounting surface has an area;
wherein at least one of the steps of dispensing the first joint material on the heat sink mounting surface and placing the thermoelectric cooler on the first joint material comprises shaping the first joint material to cover the area of the heat sink mounting surface in a range of 100 mm² to 150 mm²; and
wherein the first joint has a thickness in a range of 25 μm-50 μm.

19. The method of claim 17 wherein curing the first joint material to form the first joint comprises:
heating a temperature of the first joint material to a temperature in a range of 150° C. and 200° C.; and
maintaining the temperature of the first joint material at a temperature in a range of 150° C. and 200° C. for a time period of 30 minutes to 3 hours.

20. A method comprising:
mounting a mounting surface of a thermoelectric cooler to a photonic integrated circuit with a joint having a thermal conductivity in a range of 25 W/mK to 100 W/mK, the joint comprising a persistent organic matrix material and a conductive material dispersed within the persistent organic matrix material.
